(19) United States
(12) Patent Application Publication
(10) Pub. No.: US 2003/0063796 A1
(43) Pub. Date: Apr. 3, 2003

(54) System and method of face recognition through 1/2 faces

(75) Inventors: Srinivas Gutta, Buchanan, NY (US); Vasanth Philomin, Briarcliff Manor, NY (US); Miroslav Trajkovic, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/966,436

(22) Filed: Sep. 28, 2001

(51) Int. Cl. G06K 9/62

(52) U.S. Cl. 382/159

(57) ABSTRACT

A system and method for classifying facial image data, the method comprising the steps of: training a classifier device for recognizing facial images and obtaining learned models of the facial images used for training; inputting a vector of a facial image to be recognized into the classifier, the vector comprising data content associated with one-half of a full facial image; and, classifying the one-half face image according to a classification method. Preferably, the classifier device is trained with data corresponding to one-half facial images, the classifying step including matching the input vector of one-half image data against corresponding data associated with each resulting learned model.

### BACKGROUND OF THE INVENTION

1. Field of the Invention

The present invention relates to face recognition systems and particularly, to a system and method for performing face recognition using ½ of the facial image.

2. Discussion of the Prior Art

Existing face recognition systems attempt to recognize an unknown face by matching against prior instances of that subject's face(s). All systems developed until now however, have used full faces for recognition/identification.

It would thus be highly desirable to provide a face recognition system and method for recognizing an unknown face by matching against prior instances of half-faces.

### SUMMARY OF THE INVENTION

Accordingly, it is an object of the present invention to provide a system and method implementing a classifier (e.g., RBF networks) that may be trained to learn on half face or full facial images, and while during testing, half of the learned face model is tested against half of the unknown test image.

In accordance with the principles of the invention, there is provided a system and method for classifying facial image data, the method comprising the steps of: training a classifier device for recognizing facial images and obtaining learned models of the facial images used for training; inputting a vector of a facial image to be recognized into the classifier, the vector comprising data content associated with one-half of a full facial image; and, classifying the one-half face image according to a classification method. Preferably, the classifier device is trained with data corresponding to one-half facial images, the classifying step including matching the input vector of one-half image data against corresponding data associated with each resulting learned model.

Advantageously, the half-face face recognition system is sufficient to achieve comparable performance with the counterpart “full” facial recognition classifying systems. If ½ faces are used, an extra benefit is that the amount of storage required for storing the learned model is reduced by fifty percent (50%) approximately. Further, the computational complexity in training and recognizing on full images is avoided and, less memory storage for the template images of learned models is required.

### BRIEF DESCRIPTION OF THE DRAWINGS

Details of the invention disclosed herein shall be described below, with the aid of the figures listed below, in which:

FIG. 1 illustrates the basic RBF network classifier 10 implemented according to the principles of the present invention;

FIG. 2(a) illustrates prior art testing images used to train the RBF classifier 10 of FIG. 1; and, FIG. 2(b) illustrates ½ face probe images input to the RBF classifier 10 for face recognition according to the principles of the present invention.

### DETAILED DESCRIPTION OF THE PREFERRED EMBODIMENTS

For purposes of description, a Radial Basis Function (“RBF”) classifier is implemented although any classification method/device may be implemented. A description of an RBF classifier device is available from commonly-owned, co-pending U.S. patent application Ser. No. 09/794,443 entitled CLASSIFICATION OF OBJECTS THROUGH MODEL ENSEMBLES filed Feb. 27, 2001, the whole contents and disclosure of which is incorporated by reference as if fully set forth herein.

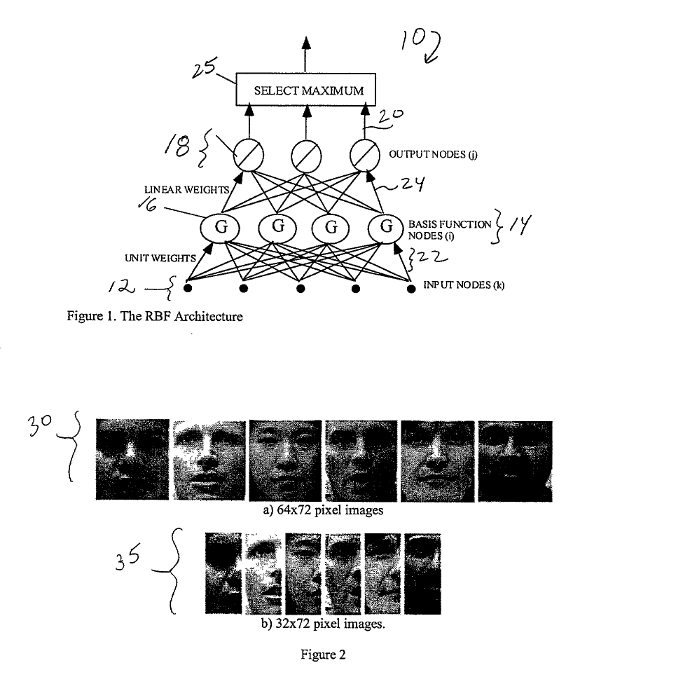

The construction of an RBF network as disclosed in commonly-owned, co-pending U.S. patent application Ser. No. 09/794,443, is now described with reference to FIG. 1. As shown in FIG. 1, the basic RBF network classifier 10 is structured in accordance with a traditional three-layer back-propagation network 10 including a first input layer 12 made up of source nodes (e.g., k sensory units); a second or hidden layer 14 comprising i nodes whose function is to cluster the data and reduce its dimensionality; and, a third or output layer 18 comprising j nodes whose function is to supply the responses 20 of the network 10 to the activation patterns applied to the input layer 12. The transformation from the input space to the hidden-unit space is non-linear, whereas the transformation from the hidden-unit space to the output space is linear. In particular, as discussed in the reference to C. M. Bishop, Neural Networks for pattern Recognition, Clarendon press, Oxford, 1997, the contents and disclosure of which is incorporated herein by reference, an RBF classifier network 10 may be viewed in two ways: 1) to interpret the RBF classifier as a set of kernel functions that expand input vectors into a high-dimensional space in order to take advantage of the mathematical fact that a classification problem cast into a high-dimensional space is more likely to be linearly separable than one in a low-dimensional space; and, 2) to interpret the RBF classifier as a function-mapping interpolation method that tries to construct hypersurfaces, one for each class, by taking a linear combination of the Basis Functions (BF). These hypersurfaces may be viewed as discriminant functions, where the surface has a high value for the class it represents and a low value for all others. An unknown input vector is classified as belonging to the class associated with the hypersurface with the largest output at that point. In this case, the BFs do not serve as a basis for a high-dimensional space, but as components in a finite expansion of the desired hypersurface where the component coefficients, (the weights) have to be trained.

In further view of FIG. 1, the RBF classifier 10, connections 22 between the input layer 12 and hidden layer 14 have unit weights and, as a result, do not have to be trained. Nodes 16 in the hidden layer 14, i.e., called Basis Function (BF) nodes, have a Gaussian pulse nonlinearity specified by a particular mean vector μᵢ (i.e., center parameter) and variance vector σᵢ² (i.e., width parameter), where i=1, . . . , F and F is the number of BF nodes. Note that σᵢ² represents the diagonal entries of the covariance matrix of Gaussian pulse (i). Given a D-dimensional input vector X, each BF node (i) outputs a scalar value yᵢ reflecting the activation of the BF caused by that input as represented by equation 1) as follows:

$${y}_{i} = {φ}_{i} ( ‖ X - {μ}_{i} ‖ ) = exp [ - {\sum }_{k = 1}^{D} \frac{{( {x}_{k} - {μ}_{ik} )}^{2}}{2 h {σ}_{ik}^{2}} ] , \qquad ( 1 )$$

Where h is a proportionality constant for the variance, Xₖ is the k^{th} component of the input vector X=[X₁, X₂, . . . , X_{D}], and μᵢₖ and σᵢₖ² are the k^{th} components of the mean and variance vectors, respectively, of basis node (i). Inputs that are close to the center of the Gaussian BF result in higher activations, while those that are far away result in lower activations. Since each output node 18 of the RBF network forms a linear combination of the BF node activations, the portion of the network connecting the second (hidden) and output layers is linear, as represented by equation 2) as follows:

$${z}_{j} = {\sum }_{i} {w}_{ij} {y}_{i} + {w}_{oj} \qquad ( 2 )$$

where zⱼ is the output of the j^{th} output node, yᵢ is the activation of the i^{th} BF node, wᵢⱼ is the weight 24 connecting the i^{th} BF node to the j^{th} output node, and Wₒⱼ is the bias or threshold of the j^{th} output node. This bias comes from the weights associated with a BF node that has a constant unit output regardless of the input.

An unknown vector X is classified as belonging to the class associated with the output node j with the largest output Zⱼ. The weights Wᵢⱼ in the linear network are not solved using iterative minimization methods such as gradient descent. They are determined quickly and exactly using a matrix pseudoinverse technique such as described in above-mentioned reference to R. P. Lippmann and K. A. Ng entitled “Comparative Study of the Practical Characteristic of Neural Networks and Pattern Classifiers.”

A detailed algorithmic description of the preferable RBF classifier that may be implemented in the present invention is provided herein in Tables 1 and 2. As shown in Table 1, initially, the size of the RBF network 10 is determined by selecting F, the number of BFs nodes. The appropriate value of F is problem-specific and usually depends on the dimensionality of the problem and the complexity of the decision regions to be formed. In general, F can be determined empirically by trying a variety of Fs, or it can set to some constant number, usually larger than the input dimension of the problem. After F is set, the mean μ_{I} and variance σ_{I}² vectors of the BFs may be determined using a variety of methods. They can be trained along with the output weights using a back-propagation gradient descent technique, but this usually requires a long training time and may lead to suboptimal local minima. Alternatively, the means and variances may be determined before training the output weights. Training of the networks would then involve only determining the weights.

The BF means (centers) and variances (widths) are normally chosen so as to cover the space of interest. Different techniques may be used as known in the art: for example, one technique implements a grid of equally spaced BFs that sample the input space; another technique implements a clustering algorithm such as k-means to determine the set of BF centers; other techniques implement chosen random vectors from the training set as BF centers, making sure that each class is represented.

Once the BF centers or means are determined, the BF variances or widths σ_{I}² may be set. They can be fixed to some global value or set to reflect the density of the data vectors in the vicinity of the BF center. In addition, a global proportionality factor H for the variances is included to allow for resealing of the BF widths. By searching the space of H for values that result in good performance, its proper value is determined.

After the BF parameters are set, the next step is to train the output weights Wᵢⱼ in the linear network. Individual training patterns X(p) comprising data corresponding to full-face and, preferably, half-face images, and their respective class labels C(p), are presented to the classifier, and the resulting BF node outputs y_{I}(p), are computed. These and desired outputs dⱼ(p) are then used to determine the F×F correlation matrix “R” and the F×M output matrix “B”. Note that each training pattern produces one R and B matrices. The final R and B matrices are the result of the sum of N individual R and B matrices, where N is the total number of training patterns. Once all N patterns have been presented to the classifier, the output weights Wᵢⱼ are determined. The final correlation matrix R is inverted and is used to determine each Wᵢⱼ.

TABLE 1
1. Initialize

| | |
|---|---|
| (a) | Fix the network structure by selecting F, the number of |
| | basis functions, where each basis function I has the |
| | output where k is the component index. |
| | ${y}_{i} = {φ}_{i} ( ‖ X - {μ}_{i} ‖ ) = exp [ - {\sum }_{k = 1}^{D} \frac{{( {x}_{k} - {μ}_{ik} )}^{2}}{2 h {σ}_{ik}^{2}} ] ,$ |
| (b) | Determine the basis function means μ_{I}, where I = 1, . . . , |
| | F, using K-means clustering algorithm. |
| (c) | Determine the basis function variances σ_{I}², where I = 1, |
| | . . . , F. |
| (d) | Determine H, a global proportionality factor for the |
| | basis function variances by empirical search |

2. Present Training

| | |
|---|---|
| (a) | Input training patterns X(p) and their class labels C(p) |
| | to the classifier, where the pattern index is p = 1, . . . , N. |
| (b) | Compute the output of the basis function nodes y_{I}(p), |
| | where I = 1, . . . , F, resulting from pattern X(p). |
| | ${R}_{il} = {\sum }_{p} {y}_{i} ( p ) {y}_{l} ( p )$ |
| (a) | Compute the F × F correlation matrix R of the basis |
| | function outputs: |
| (b) | Compute the F × M output matrix B, where dⱼ is the |
| | desired output and M is the number of output classes: |
| | ${B}_{lj} = {\sum }_{p} {y}_{l} ( p ) {d}_{j} ( p ) , where {d}_{j} ( p ) = \{ \begin{matrix}1 & if C ( p ) = j \\ 0 & otherwise\end{matrix} ,$ |
| | and j = 1, . . . , M. |

3. Determine Weights

| | |
|---|---|
| (a) | Invert the F × F correlation matrix R to get R⁻¹. |
| (b) | Solve for the weights in the network using the following |
| | equation: |
| | ${w}_{ij}^{*} = {\sum }_{l} {( {R}^{- 1} )}_{il} {B}_{lj}$ |

As shown in Table 2, classification is performed by presenting an unknown input vector Xₜₑₛₜ, corresponding to a detected half-face image, for example, to the trained classifier and, computing the resulting BF node outputs yᵢ. These values are then used, along with the weights Wᵢⱼ, to compute the output values Zⱼ. The input vector Xₜₑₛₜ is then classified as belonging to the class associated with the output node j with the largest Zⱼ output as performed by a logic device 25 implemented for selecting the maximum output as shown in FIG. 1.

TABLE 2
1. Present input pattern Xₜₑₛₜ comprising half-face image
to the classifier
2. Classify Xₜₑₛₜ

| | |
|---|---|
| (a) | Compute the basis function outputs, for all F |
| | basis functions |
| (b) | Compute output node activations: |
| | ${z}_{j} = {\sum }_{i} {w}_{ij} {y}_{i} + {w}_{oj}$ |
| (c) | Select the output zⱼ with the largest value and |
| | classify Xₜₑₛₜ as the class j. |

In the method of the present invention, the RBF input comprises n size normalized half-face gray-scale images fed to the network as one-dimensional, i.e., 1-D, vector of pixel values. Thus, for a grey-scale image of 255 colors, values may be between 0 and 255, for example. The hidden (unsupervised) layer 14, implements an “enhanced” k-means clustering procedure, such as described in S. Gutta, J. Huang, P. Jonathon and H. Wechsler entitled “Mixture of Experts for Classification of Gender, Ethnic Origin, and Pose of Human Faces,” IEEE Transactions on Neural Networks, 11(4):948-960, July 2000, incorporated by reference as if fully set forth herein, where both the number of Gaussian cluster nodes and their variances are dynamically set. The number of clusters may vary, in steps of 5, for instance, from ⅕ of the number of training images to n, the total number of training images. The width σ_{I}² of the Gaussian for each cluster, is set to the maximum (the distance between the center of the cluster and the farthest away member—within class diameter, the distance between the center of the cluster and closest pattern from all other clusters) multiplied by an overlap factor o, here equal to 2. The width is further dynamically refined using different proportionality constants h. The hidden layer 14 yields the equivalent of a functional shape base, where each cluster node encodes some common characteristics across the shape space. The output (supervised) layer maps face encodings (‘expansions’) along such a space to their corresponding ID classes and finds the corresponding expansion (‘weight’) coefficients using pseudoinverse techniques. Note that the number of clusters is frozen for that configuration (number of clusters and specific proportionality constant h) which yields 100% accuracy on ID classification when tested on the same training images.

As currently known, the input vectors to be used for training correspond to full facial images, such as the detected facial images 30 shown in FIG. 2(a), each comprising a size of, for example, 64×72 pixels. However, according to the invention, as shown in FIG. 2(b), half-face (e.g., 32×72 pixels) image data 35 corresponding to the respective faces 30 are used for training. Preferably, the half-image is obtained by detecting the eye corners of the full image using conventional techniques, and partitioning the image about a vertical center therebetween, so that ½ of the face, e.g., 50% of the full image, is used. In FIG. 2(b), thus, a half-image may be used for classification as opposed to using the whole face image for classification. For instance, step 2(a) of the classification algorithm depicted herein in Table 2, is performed by matching the ½ face test image against the previously trained model. If the classifier is trained on the full image, it is understood that ½ of the learned model will be used when performing the matching. That is, the unknown test image of half data is matched against the corresponding half images of the trained learned model.

Thus, the classifier (e.g., the RBF network of FIG. 1) is trained on full faces while during testing half of the learned face model is tested against half of the unknown test image. Experiments conducted confirm that half-face is sufficient to achieve comparable performance. If ½ face images are used, an extra benefit is that the amount of storage required for storing the learned model is reduced by fifty percent (50%) approximately. Further, the overall performance observed when identifying half-subjects faces is the same as obtained while using full faces for identification.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for classifying facial image data, the method comprising the steps of:
a) training a classifier device for recognizing facial images and obtaining learned models of the facial images used for training;
b) inputting a vector of a facial image to be recognized into said classifier, said vector comprising data content associated with one-half of a full facial image; and,
c) classifying said one-half face image according to a classification method.

2. The method of claim 1, wherein the classifier device is trained with data corresponding to full facial images, said classifying including matching said input vector of one-half image data against corresponding data associated with one-half of each resulting learned model.

3. The method of claim 1, wherein the classifier device is trained with data corresponding to one-half facial images, said classifying including matching said input vector of one-half image data against corresponding data associated with each resulting learned model.

4. The method of claim 1, wherein the classifying step comprises a Radial Basis Function Network trained for classifying inputs based on said facial image.

5. The method of claim 4, wherein the training step comprises:
(a) initializing the Radial Basis Function Network, the initializing step comprising the steps of:
fixing the network structure by selecting a number of basis functions F, where each basis function I has the output of a Gaussian non-linearity;
determining the basis function means μ_{I}, where I=1, . . . , F, using a K-means clustering algorithm;
determining the basis function variances σ_{I}²; and
determining a global proportionality factor H, for the basis function variances by empirical search;
(b) presenting the training, the presenting step comprising the steps of:
inputting training patterns X(p) and their class labels C(p) to the classification method, where the pattern index is p=1, . . . , N;
computing the output of the basis function nodes y_{I}(p), F, resulting from pattern X(p);
computing the F×F correlation matrix R of the basis function outputs; and
computing the F×M output matrix B, where dⱼ is the desired output and M is the number of output classes and j=1, . . . , M; and
(c) determining weights, the determining step comprising the steps of:
inverting the F×F correlation matrix R to get R⁻¹; and
solving for the weights in the network.

6. The method of claim 5, wherein the classifying step comprises:
presenting said half face input vector data to the classification method; and
classifying said half face image by:
computing the basis function outputs, for all F basis functions;
computing output node activations; and
selecting the output Zⱼ with the largest value and classifying said half face as a class j.

7. An apparatus for classifying facial image data comprising:
mechanism for training a classifier device for recognizing facial images and obtaining learned models of the facial images used for training;
mechanism for inputting a data vector associated with a facial image to be recognized into said classifier device, said vector comprising data content associated with one-half of a full facial image, whereby said half face image is classified according to a classification method.

8. The apparatus of claim 7, wherein the classifier device is trained with data corresponding to full facial images, wherein said classifying including matching said input vector of one-half image data against corresponding data associated with one-half of each resulting learned model.

9. The apparatus of claim 7, wherein the classifier device is trained with data corresponding to one-half facial images, wherein said classifying including matching said input vector of one-half image data against corresponding data associated with each resulting learned model.

10. A program storage device readable by machine, tangibly embodying a program of instructions executable by the machine to perform method steps for classifying facial image data, the method comprising the steps of:
a) training a classifier device for recognizing facial images and obtaining learned models of the facial images used for training;
b) inputting a vector of a facial image to be recognized into said classifier, said vector comprising data content associated with one-half of a full facial image; and,
c) classifying said one-half face image according to a classification method.

11. The program storage device readable by machine as claimed in claim 10, wherein the classifier device is trained with data corresponding to full facial images, said classifying including matching said input vector of one-half image data against corresponding data associated with one-half of each resulting learned model.

12. The program storage device readable by machine as claimed in claim 10, wherein the classifier device is trained with data corresponding to one-half facial images, said classifying including matching said input vector of one-half image data against corresponding data associated with each resulting learned model.
